(19) United States
(12) Patent Application Publication
(10) Pub. No.: US 2021/0083377 A1
(43) Pub. Date: Mar. 18, 2021

(54) ANTENNA ARRAY AND A SYSTEM EMPLOYING THE SAME

(71) Applicant: Ramot at Tel-Aviv University Ltd., Tel-Aviv (IL)

(72) Inventors: Pavel GINZBURG, Tel-Aviv (IL); Dmitri FILONOV, Tel-Aviv (IL)

(73) Assignee: Ramot at Tel-Aviv University Ltd., Tel-Aviv (IL)

(21) Appl. No.: 17/021,052

(22) Filed: Sep. 15, 2020

Related U.S. Application Data
(60) Provisional application No. 62/900,555, filed on Sep. 15, 2019.

(51) Int. Cl. H01Q 3/26; H01Q 9/04; G02F 1/31

(52) U.S. Cl. CPC H01Q 3/2676; H01Q 9/0442; G02F 1/31; H01Q 9/0414; H01Q 9/0464

(57) ABSTRACT

An antenna system comprises an antenna array having a plurality of antenna elements each having a resonator configured for emitting non-optical radiation, and a resonance tuning device for tuning a resonance frequency of the resonator. The antenna system also comprises an optical array having a plurality of light activated devices respectively aligned with the plurality of antenna elements, and a network of waveguides arranged to guide light to each light activated device. Each activated device provides electrical energy to a respective resonance tuning device upon activation by light via a respective waveguide.

### RELATED APPLICATION(S)

This application claims the benefit of priority under 35 USC 119(e) of U.S. Provisional Patent Application No. 62/900,555 filed on Sep. 15, 2020, the contents of which are incorporated by reference as if fully set forth herein in their entirety.

### FIELD AND BACKGROUND OF THE INVENTION

The present invention, in some embodiments thereof, relates to antennas and, more particularly, but not exclusively, to an antenna array and a system employing the same.

Metamaterials are artificially created media in which the electromagnetic properties can be controlled by subwavelength structuring of their unit cells. Widely employed metamaterial designs are based on arrays of compact resonators, which individual responses hybridize and give rise to collective modes. Many different approaches, based on variations of loops (magnetic resonators), wires (electric), and their combinations have been developed and experimentally demonstrated [Smith et al., Phys. Rev. Lett. 2000. Vol. 84, 18. P. 4184-4187, Schurig et al., Science. 2006. Vol. 314, 5801. P. 977-980, Simovski et al., Adv. Mater. 2012. Vol. 24, 31. P. 4229-4248, Fan et al., Opt. Express. 2018. Vol. 26, 13. P. 17541, Filonov et al. Appl. Phys. Lett. 2018. Vol. 113, 9. P. 094103, Kozlov et al., Appl. Phys. Lett. 2016. Vol. 109, 20. P. 203503, Kodera et al., Appl. Phys. Lett. 2011, 99, 031114].

Metamaterials are particularly use as components in the field of radio frequency (RF) antennas, and were successfully demonstrated in many recent studies.

Scanning antennas are in use in many modern applications, including radars, wireless communications and many others. The ability to control the radiation pattern with a high accuracy allows establishing an efficient point-to-point communication, where one or more participants can change their locations during the process. An example is a tracking radar, which needs to follow a moving target in both azimuth and elevation.

Some additional background art includes B. P. Dorta-naranjo, Electron. Lett., vol. 40, no. 17, 2004, Komissarov et al., Nat. Commun., vol. 10, no. 1, p. 1423, 2019, Holloway et al., IEEE Trans. Antennas Propag,. vol. 54, pp. 10, 2012, Glybovski et al., Phys. Rep., vol. 634, pp. 1, 2016, Pfeiffer et al., Phys. Rev. Lett., vol. 110, pp. 197401, May 2013, and Valagiannopoulos et al., Phys. Rev. B, vol. 91, pp. 115305, March 2015.

### SUMMARY OF THE INVENTION

According to some embodiments of the invention the present invention there is provided an antenna system. The antenna system comprises an antenna array having a plurality of antenna elements each having a resonator configured for emitting non-optical radiation, and a resonance tuning device for tuning a resonance frequency of the resonator. The antenna system also comprises an optical array having a plurality of light activated devices respectively aligned with the plurality of antenna elements, and a network of waveguides arranged to guide light to each light activated device, wherein each activated device provides electrical energy to a respective resonance tuning device upon activation by light via a respective waveguide.

According to some embodiments of the invention the arrays are planar.

According to some embodiments of the system comprises at least two antenna arrays and at least two optical arrays, arranged as a stack such that each optical array is adjacent to an antenna array.

According to some embodiments of the system comprises an optical controller configured for dynamically controlling coupling of input light into the waveguides so as to dynamically vary a light propagation path along the optical array, hence to control at least one of a shape and a direction of a collective non-optical radiation emitted by the antenna array.

According to some embodiments of the invention the controller is configured to vary the light propagation path according to a fifth-generation communication protocol.

According to some embodiments of the invention at least one of the resonators comprises a split ring resonator.

According to some embodiments of the invention at least one of the resonance tuning device comprises a varactor.

According to some embodiments of the invention at least one of the light activated device comprises a photodiode.

According to some embodiments of the invention the antenna elements and the light activated device are configured to allow each resonance tuning device to reversibly switch a respective resonator between an active and a non-active state for a frequency of the non-optical radiation responsively to the light.

According to some embodiments of the invention the antenna elements and the light activated device are configured to allow each resonance tuning device to shift a resonance frequency of a respective resonator by at least 5%.

According to some embodiments of the invention the non-optical radiation is at a frequency of from about 500 MHz to about 6 GHz. According to some embodiments of the invention the non-optical radiation is at a frequency of more than 6 GHz. According to some embodiments of the invention the non-optical radiation is at a frequency of at least 24 GHz.

According to an aspect of some embodiments of the present invention there is provided a portable communication device. The portable communication device comprises the system as delineated above and optionally and preferably as further detailed below.

According to an aspect of some embodiments of the present invention there is provided a base station for distributing communication signals to and from individual portable communication devices. The base station comprises the system as delineated above and optionally and preferably as further detailed below.

According to an aspect of some embodiments of the present invention there is provided an RFID device. The RFID device comprises the system as delineated above and optionally and preferably as further detailed below.

According to an aspect of some embodiments of the present invention there is provided a radar system. The radar system comprises the system as delineated above and optionally and preferably as further detailed below.

According to an aspect of some embodiments of the present invention there is provided an antenna system. The antenna system comprises a plurality of antenna elements arranged on a ceramic element, each antenna element having a resonator and a resonance tuning device for tuning a resonance frequency of the resonator; a metal loop configured for exciting a magnetic dipolar mode in the ceramic element; and a plurality of light activated devices arranged such that each light activated device provides electrical energy to a respective resonance tuning device upon activation by light.

According to some embodiments of the invention the ceramic element is shaped as a disc, and the antenna elements are arranged to form circular sectors over the disc.

According to an aspect of some embodiments of the present invention there is provided a method of controlling characteristics of an antenna array. The method comprises directing light to a plurality of light activated devices to produce electrical signals; and coupling the electrical signals to an antenna array having a plurality of resonators configured for emitting non-optical radiation, and a plurality of resonance tuning devices that are configured to receive the electrical signals and are arranged to tune resonance frequencies of the resonators, responsively to the electrical signals.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee.

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A, 1B and 1C are images (FIGS. 1A-B) and a schematic illustration (FIG. 1C) of electro-optically tunable artificial magnon resonance in a metamaterial-based sphere, according to some embodiments of the present invention;

FIG. 2A shows numerically extracted effective metamaterial parameters as a function of frequency for the unit cell shown in FIG. 1C, obtained in experiments performed according to some embodiments of the present invention;

FIG. 2B shows tunability of the real part of the numerically extracted effective permeability, obtained in experiments performed according to some embodiments of the present invention;

FIG. 3 shows degradation of resonant behavior of the effective permeability with the drop in tolerance of the lumped elements nominals, obtained in experiments performed according to some embodiments of the present invention;

FIGS. 4A and 4B are a schematic illustration (FIG. 4A) and a graph (FIG. 4B) showing artificial RF magnon resonant tuning with visible light, as calculated according to some embodiments of the present invention;

FIGS. 5A, 5B, 5C and 5D show numerical analysis of back scattering spectra for different angle of incidence and polarization, obtained in a study performed according to some embodiments of the present invention;

FIG. 6A shows experimental demonstration of optical tunability of a single unit cell, obtained in experiments performed according to some embodiments of the present invention;

FIG. 6B shows experimental demonstration of optically tuned differential backscattering of an artificial magnon resonance, obtained in experiments performed according to some embodiments of the present invention;

FIG. 6C is a schematic illustration of a measurement setup, used in the experiments performed to obtain the data shown in FIGS. 6A and 6B;

FIGS. 7A and 7B are a schematic illustration (FIG. 7A) and an image (FIG. 7B) of an optically switchable scanning antenna, demonstrated in experiments performed according to some embodiments of the present invention;

FIG. 8 shows S-parameter spectrum of cylinder dielectric resonator, excited with a non-resonant conducting loop, according to some embodiments of the present invention;

FIG. 9 shows resonance spectral shift of SRR resonance, obtained in experiments performed according to some embodiments of the present invention;

FIG. 10 is a schematic illustration of an antenna scanning performance, obtained in experiments performed according to some embodiments of the present invention;

FIG. 11 is a schematic illustration of an antenna system, according to some embodiments of the present invention;

FIG. 12 is a schematic illustration of a representative example of an antenna element, according to some embodiments of the present invention; and

FIG. 13 is a schematic illustration of an appliance which comprises an antenna system, according to some embodiments of the present invention.

### DESCRIPTION OF SPECIFIC EMBODIMENTS OF THE INVENTION

The present invention, in some embodiments thereof, relates to antennas and, more particularly, but not exclusively, to an antenna array and a system employing the same.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

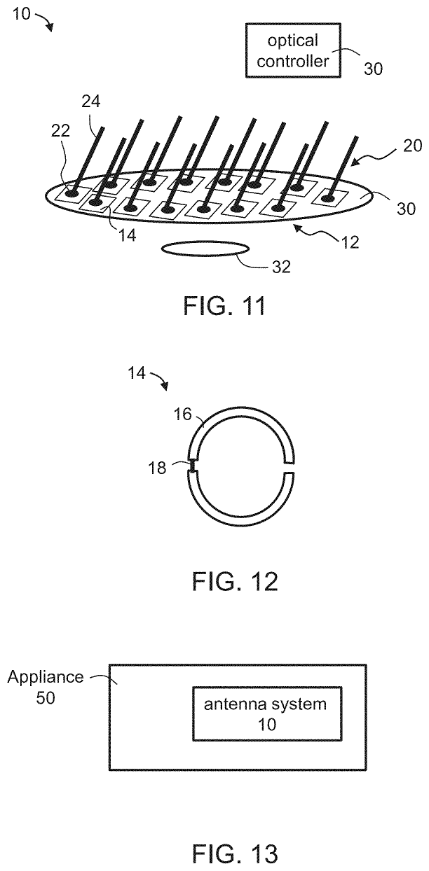

Referring now to the drawings, FIG. 11 illustrates an antenna system 10, according to some embodiments of the present invention. Antenna system 10, optionally and preferably comprises an antenna array 12 having a plurality of antenna elements 14.

A representative example of an antenna element 14 is illustrated in FIG. 12. Antenna element 14 can comprise a resonator 16 configured for emitting non-optical radiation, and a resonance tuning device 18 for tuning a resonance frequency of resonator 16. In the schematic illustration of FIG. 12, resonator 16 is embodied as a split ring resonator (SRR) having a generally circulat shape, but this need not necessarily be the case, the shape of the SRR can have other geometries such as square, rectangle, hexagon, triangle, and the like. Further, it is not necessary for the resonator 16 to be an SRR. Other types of resonators, such as, but not limited to, a complementary openings resonant ring structure, a nested split ring, a sphere, a spiral loop, a split ring having more than two gaps, an omega shaped element, a pair of cut wires, electrical LC elements, and the like

Resonance tuning device 18 can be of any type that can tune the resonance frequency of resonator 16. Preferably, resonance tuning device 18 is a device that is capable of changing the capacitance and/or inductance of resonator 16. For example, resonance tuning device 18 can comprise a varactor diode or a pn-junction or the like. In some embodiments of the present invention resonance tuning device 18 is a varactor diode.

The non-optical radiation emitted by resonator 16 is typically at a frequency of from about 500 MHz to about 6 GHz, but in some embodiments of the present invention can be more than 6 GHz, e.g., more than 12 GHz, e.g., at least 24 GHz.

Referring again to FIG. 11, system 10 optionally and preferably comprises an optical array 20 having a plurality of light activated devices 22 respectively aligned with antenna elements 14. Light activated devices 22 can be embodied, for example, as photodiodes. In the schematic illustration of FIG. 11 arrays 12 and 20 are co-planar, in which case devices 22 and elements 14 engage the same plane. However this need no necessarily be the case, since arrays 12 and 20 can engage different plane parallel to each other, in which case the alignment between devices 22 and elements 14 is optionally and preferably perpendicular to the planes. Also contemplated, are embodiments in which one or both of arrays 12 and 20 is non-planar. Each of these configurations, each of devices 22 is preferably aligned with an antenna element 14.

Array 22 optionally and preferably also comprises a network of waveguides 24 arranged to guide light to each of light activated devices 22. In operation, once a particulate device 22 is activated by light via a respective waveguide 24, it provides electrical energy to the respective resonance tuning device 18 of the respective element 14, thereby tuning the resonance frequency of the respective resonator.

In some embodiments of the present invention antenna elements 14 are arranged on a ceramic element 30. The ceramic element 30 is preferable selected to facilitate exciting a magnetic dipolar mode in it. A representative example of a ceramic element suitable for the present embodiment is a ZrO2-SnO2-TiO2 ceramics, but other ceramic materials are also contemplated. The magnetic dipolar mode can be exited in ceramic element 30, by applying energy to element 30, using an energy delivering element 32. In the schematic illustration of FIG. 11 the delivering element 32 is embodied as metal loop 34, but other types of elements are also contemplated.

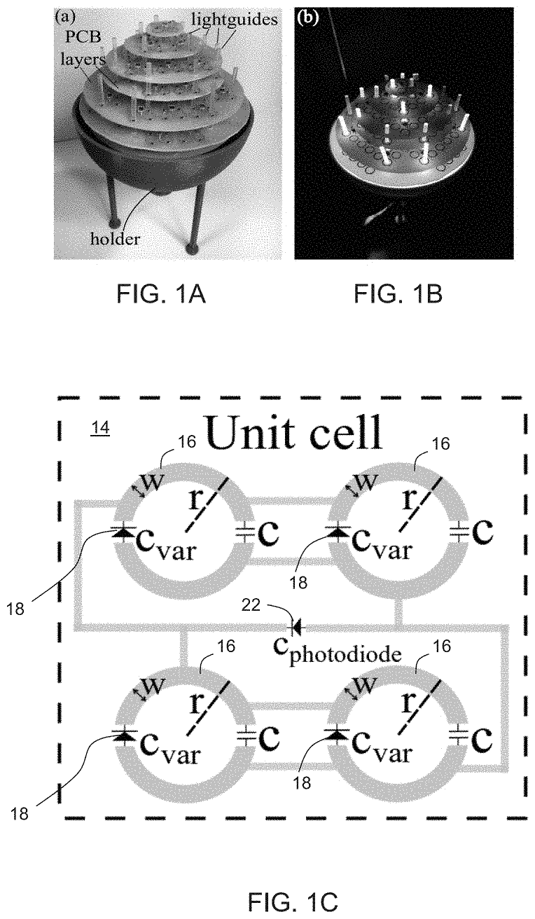

In some embodiments of the present invention, one or more, e.g., each, of the elements 14 comprises more than one pair of resonator 16 and resonance tuning device 18, forming together a unit cell of system 10. In these embodiments the same light activated device 22 provides electrical energy to all the resonance tuning device 18 of element 14. This embodiment is illustrated in FIG. 1C for the case of four pair of resonator 16 and resonance tuning device 18 per element 14.

When element 14 comprises more than one pair of resonator 16 and resonance tuning device 18 (a unit cell) the respective resonators 16 resonate collectively by virtue of the near field coupling there amongst.

As used herein “collective resonance” refers to a delocalized resonant oscillation of at least one physical field (e.g., electric field, magnetic field, electromagnetic field). The resonant oscillation is “delocalized” in the science that it occurs over a region (an area or a volumetric region) that contains a plurality of cells.

The collective resonance provides element 14 with a macroscopic property that is frequency dependent. For example, the collective resonance can result in a frequency dependent magnetic permeability μ(ω) and/or frequency dependent magnetic permittivity ε(ω).

In some embodiments of the present invention system 10 comprises two or more antenna arrays 12 and respective two or more optical arrays 20. In these embodiments the arrays can be arranged, for example, as a stack such that each optical array 20 is adjacent to an antenna array 12. The advantage of these embodiments is that they provide three-dimensional configuration and facilitate emitting and receiving radiation from a plurality of direction wherein at least three of these directions do not engage the same plane.

System 10 can also comprises an optical controller 30. Controller 30 dynamically controls the coupling of input light into waveguides 24 so as to dynamically vary a light propagation path along optical array 20. For example, controller can couple light into some of the waveguides 24 so but not the others, thereby allowing only some of the light activated devices 22 to activate the respective tuning devices. This is advantageous because it allows controlling the shape and/or direction of a collective non-optical radiation emitted by antenna array 12. In some embodiments of the present invention controller 30 vary the light propagation path according to a fifth-generation communication protocol.

The ability to tune the resonance frequency of the antenna elements 14 can be exploited for switching. In these embodiments, elements 14 and light activated device 22 are configured to allow each resonance tuning device 18 to reversibly switch a respective resonator 16 between an active and a non-active state for the frequency of the non-optical radiation responsively to the light. This is optionally and preferably achieved by configuring the antenna elements 14 and the light activated devices 22 to allow each resonance tuning device 18 to provide a sufficient shift to the resonance frequency of a respective resonator 16. Preferably, the shift to the resonance frequency is by at least 5%, more preferably by at least 10%, more preferably by at least 20%.

The arrangement of the antenna elements of array 12 can be selected to provide directionality to the collective radiation emitted by the respective elements. For example, ceramic element 30 can be shaped as a disc, and the antenna elements 14 can be arranged to form circular sectors over the disc. Each sector can optionally and preferably be constructed as a single unit cell in which all the same light activated device 22 provide electrical energy to all the resonance tuning devices 18 within the sector. The present inventors demonstrated that such an exemplified arrangement can be used to emit radiation at any direction along the perimeter of the disk.

System 10 can be a component any many appliances. FIG. 13 is a schematic illustration of an appliance 50 which comprises system 10. Appliance 50 can include any system that requires an antenna for transmitting waves. For example, appliance 50 can be portable communication device (e.g., a cellular phone), a base station for distributing communication signals to and from individual portable communication devices, or an identification tag (e.g., RFID device), or a radar system, or the like.

When system 10 is incorporated in an identification tag it can be used for identification. The advantage of using system 10 in an identification tag is that it exhibits relatively high scattering cross sections, with a resonant position that is tunable over a large bandwidth. This allows manufacturing a large number of identification tags that can be distinguished from each other, and which can therefore be used to identify a large number of objects (not shown), each carrying one of these tags. The identification tags can be manufactured with a different and distinguishable resonance spectrum for each tag, or, more preferably, they can be manufactured as identical tags and then be tuned each to a different resonance spectrum. In use, an identification tag reader transmits radiation (e.g., RF radiation) to the tag. The system 10 scatters the radiation to provide scattered radiation. The identification tag reader receives the scattered radiation, and analyzes the received radiation to extract its spectral content. Since the tag has a distinguishable resonance spectrum, the identification tag reader can identify the tag based on the extracted spectral content.

An additional level of detectability of identification the tag according to some embodiments of the present invention can optionally and preferably be achieved with time modulation of the scattering cross section, for example, by modulating the light that activates the light activated devices 22 of system 10. This is particularly useful in a cluttered environment. Since the scattering off system 10 that is incorporated in the tag is modulated in time, the scattered radiation acquires a frequency shift which can be easily detected and distinguished over the cluttered environment, for example, by introducing a filter at the path along which the radiation propagate.

When system 10 is incorporated in a communication system, radiation that encodes data can be directed to system 10, or transmitted by system 10, in response to the light controlled by the controller 30 in accordance with a defined communication protocol.

As used herein the term “about” refers to ±10%.

The word “exemplary” is used herein to mean “serving as an example, instance or illustration.” Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments.” Any particular embodiment of the invention may include a plurality of “optional” features unless such features conflict.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

### Example 1

### 4D Optically Reconfigurable Volumetric Metamaterials

Metamaterials are artificially created media, which allow introducing additional degrees of freedom into electromagnetic design by controlling constitutive material parameters. Reconfigurable time-dependent metamaterials can further enlarge those capabilities by introducing a temporal variable as an additional controllable parameter. This Example demonstrates a first-of-its-kind reconfigurable volumetric metamaterial-based scatterer, wherein the electromagnetic properties are controlled dynamically with light. In particular, hybridized resonances in arrays of split ring resonators give rise to a collective mode that presents properties of artificial high-frequency magnetism for centimeter waves. Resonant behavior of each individual ring is controlled with a photocurrent, which allows the fast tuning of macroscopic effective permeability. Thus, the artificial gigahertz magnon resonant excitation within a subwavelength spherical scatterer is governed by light intensity. Four-dimensional control over electromagnetic scattering in both space and time opens new venues for modern applications, including wireless communications and automotive radars to name just a few.

### Introduction

Metamaterials are artificially created media in which the electromagnetic properties can be controlled by subwavelength structuring of their unit cells. As a result, quite peculiar values of material susceptibilities can be obtained. Widely employed metamaterial designs are based on arrays of compact resonators, which individual responses hybridize and give rise to collective modes. Many different approaches, based on variations of loops (magnetic resonators), wires (electric), and their combinations have been developed and experimentally demonstrated. The metamaterial approach has been found to be especially successful under conditions where incident illumination wavelength is relatively long. For example, GHz metamaterials can be fabricated by employing standard printed board lithographic techniques. Thus, the field of radio frequency (RF) antennas has benefited from introducing material degrees of freedom as an additional optimization parameter, as was successfully demonstrated in many recent studies.^{[10-12]} It is worth noting, however, that the vast majority of metamaterial-based devices are static, i.e., their electromagnetic properties cannot be controlled after fabrication. This low flexibility can be a significant disadvantage in many cases. For example, a typical invisibility cloaking device has a very narrow operational bandwidth, which is a direct consequence of the resonant nature of the negative index metamaterial that was employed in the celebrated demonstration.^{[13]} However, for application in radar invisibility, the negative index type of countermeasure fails against any basic frequency hopping system, which utilizes a sufficient bandwidth.^{[14]} Therefore, the ability of dynamic control over metamaterial parameters is a highly demanded functionality and has a very broad range of practical applicability, not necessarily limited to radar scenarios.

Control over effective material properties can be achieved in many ways, including, for example, mechanical deformation and electronic control that are among the preferable and already proven strategies. The latter approach utilizes electrically driven elements where impedance can be controlled by either external voltage or current. Two-dimensional versions of metamaterials (metasurfaces) especially benefited from this approach, and many useful practical devices have been developed. For example, it was shown that laws of refraction can be controlled almost on demand. Furthermore, several beam steering devices, where expensive phase shifting elements were replaced by low cost varactor diodes, were designed and have demonstrated remarkable electromagnetic performance.

However, the direct mapping of those techniques from two-dimensional prototypes to volumetric architectures is extremely challenging. The reason is the need for conducting wiring, which must connect each individual resonating element inside the volume to a drive. The result is that an undesirable branched network of conductors is created inside a structure and starts affecting its electromagnetic properties, even if not prevailing over it.

This Example proposes a paradigm solution to this dynamic reconfigurability problem and demonstrate a first-of-its-kind tunable volumetric metamaterial. In particular, our architecture is based on arrays of split ring resonators (SRRs), serving as microscopic magnetic dipoles. Each SRR is loaded with a varactor, which in turn is driven by a photodiode. The tandem is activated with light and does not have any physical connection (wires) to an adjutant unit cell. The light is guided into the volume of the structure by optical fiber bundles that do not scatter centimeter waves significantly [see the inset in FIG. 1A].

Under uniform illumination, the collective resonance of the structure can be reconfigured with light. In particular, this Example show that artificial magnon resonance of a metamaterial-based sphere can be controlled with light, and the resulting scattering cross-sections can be tuned dynamically.^{[23]}

### Metamaterial Design

Metamaterial architecture is based on ordered arrays of SRRs, chemically etched on printed circuit boards (PCB). Each individual resonator acts as a magnetic dipole within vertices of an artificial material crystal.

FIGS. 1A-C are images (FIG. 1A-B) and a schematic illustration of electro-optically tunable artificial magnon resonance in a metamaterial-based sphere, according to some embodiments of the present invention. FIG. 1A is a photograph of a sphere with a plastic 3D-printed bottom holder, FIG. 1B is a photograph of sphere with optical drive switched on and the corresponding “bright” regime, and FIG. 1C illustrates a unit cell forming the metamaterial.

Near-field coupling between all unit cells in the artificial crystal, governs the electromagnetic properties of the homogenized structure. The unit cell design of the present embodiments contains four split rings and interconnecting wires (within a single cell only). This architecture was selected to reduce the number of light-rectification photodiodes. In this Example, the adjutant unit cells do not have direct wire connection with each other; as a result, no conduction current flow between the cells. Conductive coupling between the metamaterials' unit cells can give rise to difficulties in defining local effective susceptibilities, as, for example, in the case of wire media. Another strategy to prevent high-frequency current flow is to introduce decoupling coils. However, this approach can significantly complicate the design and necessitate the use of lumped elements with high tolerance in their nominals. This approach is also associated with additional ohmic losses within a structure. In addition, the form factor of lumped elements starts affecting electromagnetic scattering from the entire structure, which can result in additional degradation of performance.

To extract the effective parameters of the structure of the present embodiments, the numerical retrieval in a waveguide geometry was done using CST Microwave Studio, based on the Nicolson-Ross-Weir method. A typical two-port waveguide system, with relevant dimensions of 20×20×60 mm, determined by the specific frequency range, was used. Complex-valued transmission and reflection coefficients (S-parameters) were calculated for three different orientations, corresponding to the main crystallographic axis of the metamaterial, and the permittivity and permeability tensors were extracted following the formulation reported at.

The following parameters of the structure were chosen after a set of optimizations: radius of SRRs r=4 mm, w=1 mm, c=680 pF, where r is the inner radius of the ring, w is the difference between the outer radius and the inner radius, and c is the static capacitance at the ring's gap. The substrate was FR4 (dielectric constant permittivity ε=4.43, dielectric loss tangent tgδ=0.025) of 1.5 mm in thickness, and the material of the SRR was copper (conductivity of 5.96×10⁷ S/m) [see FIG. 1C].

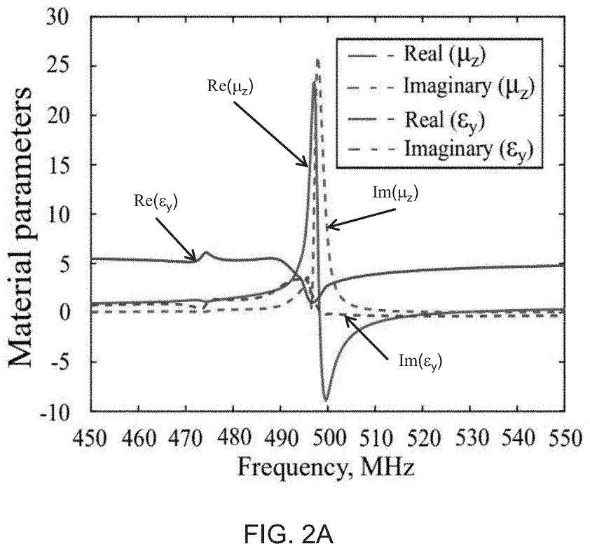

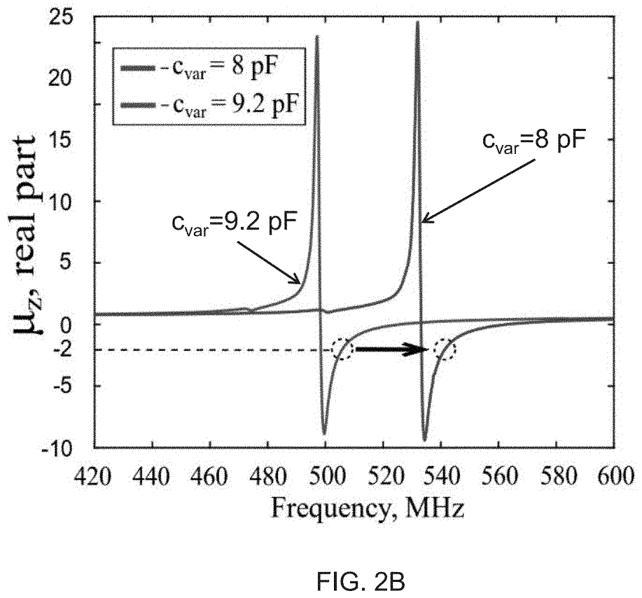

FIG. 2A shows numerically extracted effective metamaterial parameters as a function of frequency for the unit cell shown in FIG. 1C, and FIG. 2B shows tunability of the real part of the numerically extracted effective permeability. Different nominals of the varactor diodes correspond to different light intensities, applied on the photoelement.

Both the permittivity and permeability have a strong resonant absorption peak ‘that results in significantly modified effective values of the real parts in its vicinity. The magnetic phenomenon, which is the subject for the optimization, is stronger in the case of sharp resonances. The magnetic and electric phenomena are decoupled in cases when deeply subwavelength scatterers are considered. Therefore, electromagnetic properties—related to relative permeability (μ) values, e.g., −2 for achieving magnon resonance in a deeply subwavelength sphere—do not depend on values of a relative permittivity ε(although a far-field scattering pattern is affected). A broad range of negative permeability values can be obtained, ensuring a resonant response even in the presence of retardation effects (μ≈2 condition is valid only for point-like scatterers and changes with the non-negligible size of a scatterer).

Artificial magnon resonance resembles a celebrated phenomenon of localized plasmon resonances, taking place in noble metal nanoparticles. Duality of Maxwell's equations allows drawing analogies between the electric and magnetic phenomena, while the field of metamaterials enables replicating material properties. The polarizability of a small magnetic sphere is given by

$${α}_{m} = 4 π {r}^{3} ( \frac{{μ}_{r} - 1}{{μ}_{r} + 2} ) \qquad ( EQ . 1.1 )$$

where μᵣ is the relative permeability of the material, and r is the radius of the sphere. The modified expression, which includes retardation effects and radiation reaction, is given by

$${α}_{m} = 4 {π ( \frac{1}{{r}^{3}} \times \frac{{μ}_{r} + 2}{{μ}_{r} - 1} - i \frac{2}{3} {k}^{3} - \frac{{k}^{2}}{r} )}^{- 1} \qquad ( EQ . 1.2 )$$

where k is the free space wavenumber of the incident radiation. EQ. 1.1 shows that the resonance is obtained when Re(μᵣ)=−2, and the quality factor of the peak is governed by the radiation losses (EQ. 1.2). Note that the material properties are frequency-dependent and, therefore, photodiodes allow controlling the resonant condition (EQ. 1.2) by changing capacitances of varactors.

Tunability properties of the structure will now be discussed. For this purpose, several capacitance nominals of the varactor diodes were chosen to demonstrate the tunability characteristics. Decrease in capacitance (demonstrated in the following experiment with light) shifts the resonance of the structure to higher frequencies, which is consistent with the lumped circuit theory (see FIG. 2B). An efficient tuning can be obtained within the frequency band, corresponding to 10% of the carrier frequency, allowing normal performance for many practical applications.

Tolerance in lumped element nominals can be quite important if many of them are used in a structure with a strong resonant response. Furthermore, as shown below, it was demonstrated experimentally by the inventors that the capacitance tuning can be performed with light. It means that non-uniform illumination of photodiodes and different efficiencies of the later elements results in a pseudo-random spread of capacitances within a unit cell.

To estimate the impact of these factors on performance degradation, a statistical model was developed. The parametric retrieval was performed on six unit cells, placed inside the waveguide with dimensions 20×20×60 mm. Capacitance nominals within each unit cells were taken to be equal since the same photodiode drives the voltage drop on the elements. Nominals in the different unit cells were taken according to the following statistical model:

Cᵥₐᵣ=C₀−ΔCᵥₐᵣ·rand([0, 1]), (EQ. 1.3)

where C₀=9.2 pF and ΔC is varied from zero (all the elements are the same without a spread) to 1.2 pF (corresponding to the maximum ΔCᵥₐᵣ for the Skyworks SMV 1413 varactors, driven by one PIN photodiode BWP34) and rand([0, 1]) is a random variable with a uniform distribution between 0 and 1. This particular form was chosen to resemble the experimental scenario, where Cᵥₐᵣ=C₀ is the capacitance in the “dark” mode, and its value can only be reduced with the introduction of a photocurrent. For each specific value of ΔCᵥₐᵣ n=5 realizations have been considered. Permeability dispersion was extracted for each particular case and then averaged over the number of realizations.

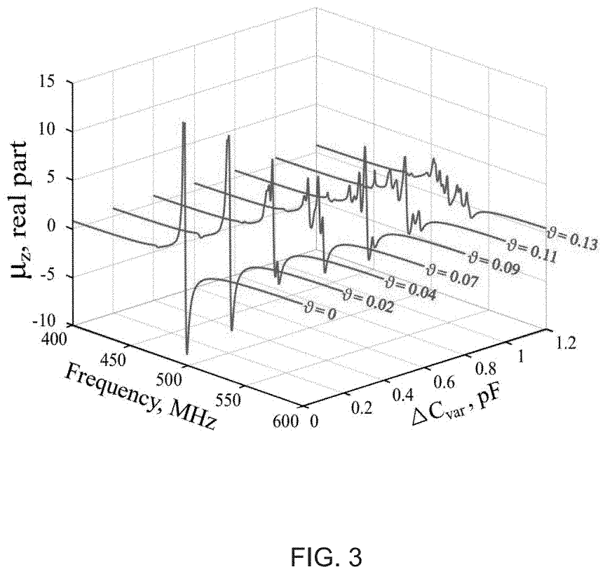

FIG. 3 shows degradation of resonant behavior of the effective permeability with the drop in tolerance of the lumped elements nominals. Real part of the effective permeability as a function of frequency is plotted for different values of the tolerance ΔCᵥₐᵣ. FIG. 3 demonstrates that around the critical value, ϑ=ΔCᵥₐᵣ/C₀=0.13, the effective permeability does not reach the value of −2. Large values of ϑ lead to almost complete elimination of the effect, and the relative permeability averages to unity.

### Tunable Artificial Magnon Resonance

This section discusses the electromagnetic scattering performance of 3D metamaterial-based sphere. Numerical analysis was conducted using a frequency domain solver, implemented within the CST Microwave Studio software. The final design of the scatterer consisted of 11 PCB layers with printed unit cells, which were assembled to form an approximately spherical shape with a radius of 60 mm. The distance between the layers was h=9 mm. The geometry and materials of the unit cells were the same as those investigated in the previous section.

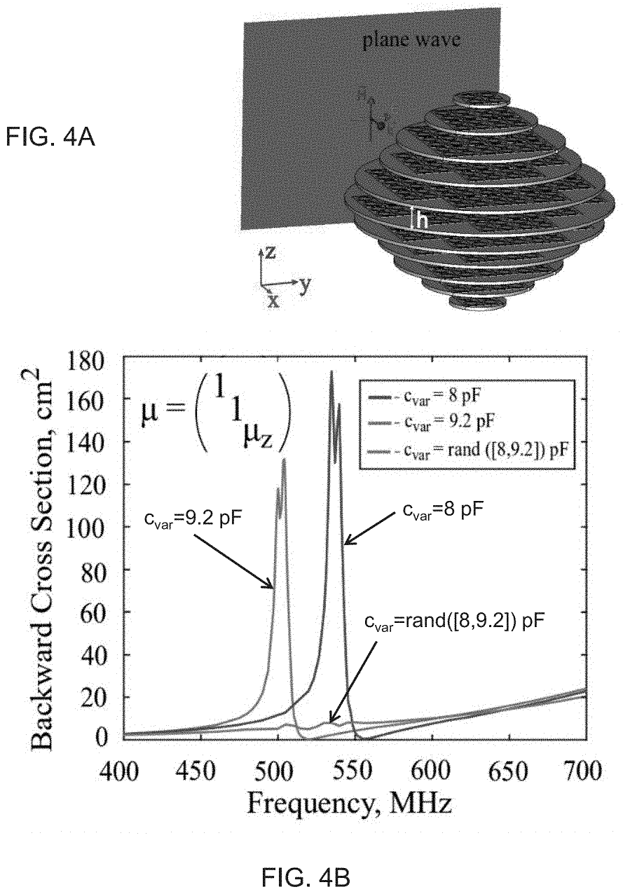

FIG. 4A schematically illustrates the basic setup for the numerical analysis: a plane wave is incident on the metamaterial-based spherical scatterer. The analysis was made by imposing open boundary conditions. The numerical modeling replicates performances of photodiodes with effective lumped elements. The varactors capasitance change was estimated via a voltage drop, which in turn is proportional to the light intensity, driving the process. Additional capacitance of photodiodes was taken into account by plugging nominals, declared in a datasheet. The maximal change of 1.2 pF was imposed in order to correlate the numerical investigations with the experimental data.

The backward scattering cross-section was calculated for the following values of the varactor diodes:Cᵥₐᵣ=9.2 pF, corresponding to the “dark” regime; Cᵥₐᵣ=8 pF, corresponding to the uniform “bright” regime; and ΔCᵥₐᵣ=1.2 pF, corresponding to the inhomogeneous illumination case. In the ideal case, the observed resonance shift was around 10% with respect to the carrier frequency. FIG. 4B shows backward scattering cross-section spectra of the sphere in “dark” mode, “bright” mode, and non-uniform illumination (ϑ=0.13). For an inhomogeneous illumination, the resonant scattering peak vanishes for the critical value of ΔCᵥₐᵣ.

Since the structure is strongly anisotropic, its scattering capabilities in the case of inclined incidence was investigated. The key parameter in this case is the projection of magnetic field polarization on the major axis of the structure.

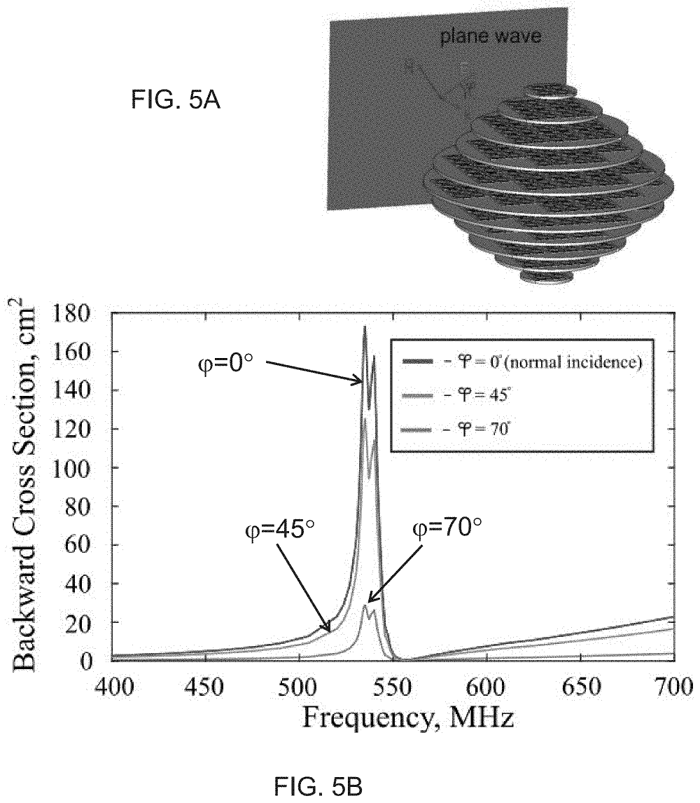

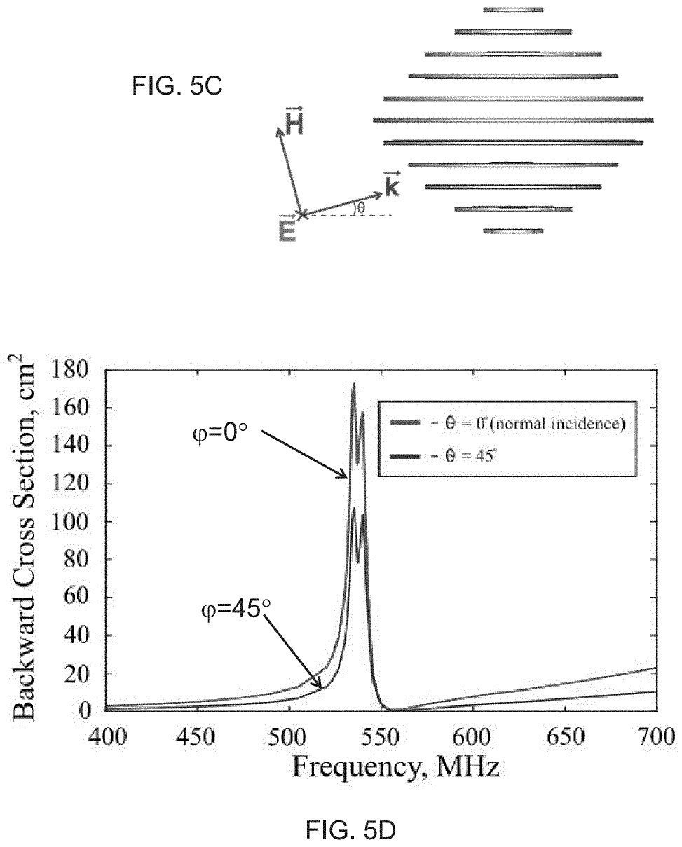

The numerical analysis of the back scattering spectra for different Euler angles of incidence and polarization, is described in FIGS. 5A-D. FIG. 5A illustrates an interaction scenario of normal incidence, where k-vector of the wave is parallel to the planes, containing SRRs and field's polarization is rotated. In FIG. 5A, φ is an angle between electric field and the major axis of the metamaterial, and k-vector is in the plane, containing the resonators. FIG. 5B shows back scattering spectra for different angles (scenario of FIG. 5A). FIG. 5C illustrates another interaction scenario where both the k-vector and the H-field polarization are rotated. FIG. 5D shows back scattering spectra for two different values of the angle θ that is defined in FIG. 5C. FIGS. 5B and 5D demonstrate a drop of the scattering peak with increasing the polarization mismatch. Note that that 45° polarization mismatch case leads to slightly different peak heights, underlining the contribution of anisotropic permittivity contribution.

### Electro-Optical Tuning

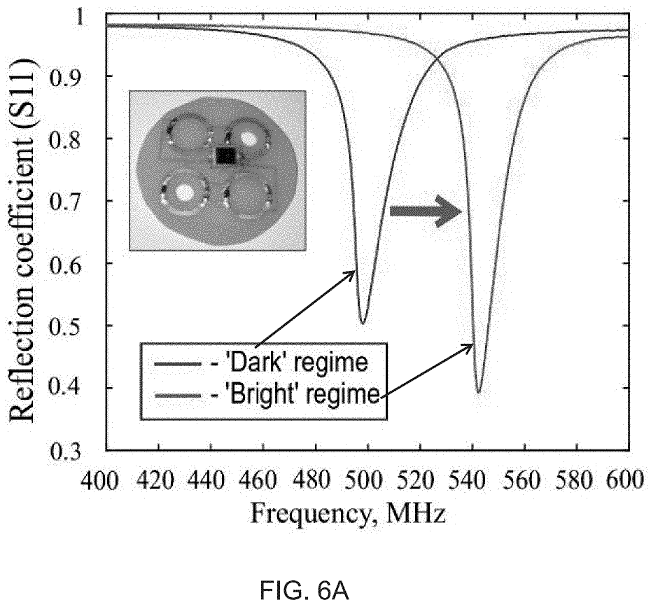

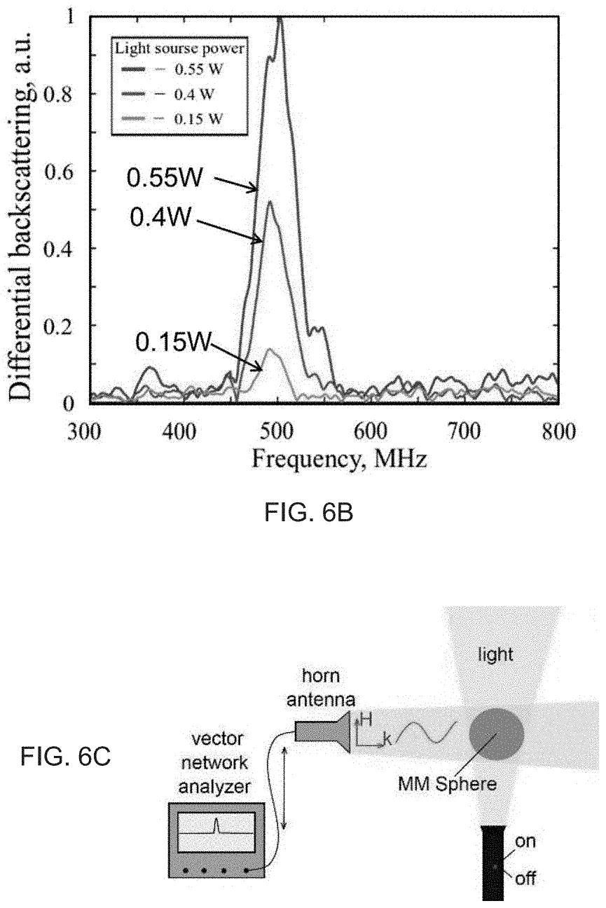

A single unit cell was constructed and its resonant properties were investigated. The unit cell was fabricated on FR-4 PCB (dielectric constant of 4.43, a thickness of 1.5 mm) by chemical etching. Lumped elements (Multilayer Ceramic Capacitors 500R07S0R5AV4T and Skyworks SMV 1413 varactors) were soldered to the SRRs' gaps. The capacitance of each varactor diode was controlled by soldering the BWP34 photodiode on the PCB. Complex reflection coefficient (S₁₁) of the structure was acquired using a small magnetic probe antenna connected to the transmitting port of a Vector Network Analyzer (VNA E8362B). The probe was placed 5 mm above the unit cell and two regimes of illumination were tested: “dark” with no light source and “bright” with the light source turned on. In the “bright” regime, the photodiode was illuminated with 100 mW red laser pointer (λ=655 nm). FIG. 6A shows the S₁₁ parameter as a function of frequency obtained in the Experiments.

One of the main challenges in constructing volumetric tunable metamaterial is to provide a drive to each individual cell. Electrical wiring of a circuit board significantly affects antenna performance by introducing additional coupling channels. Furthermore, the introduction of bunched metal strips influences the scattering characteristics; and, in fact, can even govern the interactions with incident radiation. This problem can be at least partially solved in reflect arrays configuration, where the wires are hidden behind the ground plane that isolates them from antenna elements. Those architectures are planar and cannot be extended to the third dimension. In this Example, the concept of electro-optical drive distributed over an optical network is introduced.

The experimental sample was fabricated following the effective medium design, maintaining the same geometric parameters as in the numerical modeling described above. Overall, the structure had 1080 lumped elements. To provide an efficient scattering cross-section modulation with light, the capacitance of each varactor diode was controlled by the BWP34 photodiodes, as in the case of unit cell discussed earlier.

The light was guided to the diodes using 22 wide fiberglass fibers (shown in FIGS. 1A and 1B), which were roughened on purpose to out-scatter a sufficient optical intensity. Rectangular wideband horn antenna connected to the transmitting port of a vector network analyzer (VNA E8362B) was used as an excitation source. The scatterer was then located in the far-field of the antenna (about 2 meters apart). The backward scattering cross-section was obtained using the same horn antenna to collect the signal from the sphere. Light illumination was provided by a halogen fiber optic illuminator (Thorlabs OSL2, Thorlabs, Inc.). The backward cross-section spectra were measured with and without the light illumination.

Differential RCS was measured as a difference between backward scattering cross-sections of object in dark and bright regimes: σ^{dif}=|S₁₁^{dark}|−|S₁₁^{bright}|. The current realization demonstrates the case in which ΔCᵥₐᵣ is above the critical value, corresponding to the degradation of the scattering peak with the light source switched on. The results are shown in FIG. 6B, where an increment of light intensity leads to vanishing of the peak, and therefore to the maximization of the differential RCS (the 0.55W line in FIG. 6B). For moderately low intensity, the light-induced modulation was moderately low, resulting in vanishing differential RCS as a function of frequency. This typical example demonstrates the capability to obtain amplitude modulation of RF signals with light. The light-induced elimination of the scattering peak corresponds to the random nominal spread presented in FIG. 3. Slightly different light intensities, delivered to the unit cells, reduce the element's tolerance, which cause to the peak smearing.

### Conclusions

In this Example, volumetric reconfigurable metamaterial was designed and experimentally demonstrated, and the concept of tunable RF magnon resonance that is controllable with light was developed. The architecture is based on arrays of SRRs that serve as microscopic magnetic dipoles, which hybridize to a collective magnetic mode. Each SRR was loaded with a tandem of a varactor and a driving photodiode, which allowed the replacement of branched conducting wire network with optical fibers that are transparent to RF waves. This Example showed that artificial magnon resonance within the metamaterial-based sphere can be controlled by light and that scattering cross-sections are affected by it in real time. This demonstrates the ability of the system of the present embodiments to be used, for example, in the field of wireless communications and RFID technologies, where real-time control over scattering cross-sections is advantageous. The geometric degrees of freedom demonstrated in this Example can be realized also by additive manufacturing techniques.

### Example 2

### Optically Switchable Scanning Antenna

The ability to obtain dynamical control over an antenna radiation pattern is desired in a vast range of applications, including wireless communications, radars and many others. Widely used approaches include mechanical scanning with antenna apertures and phase switching in arrays. The Inventors found that those solutions have severe limitations, related to scanning speeds and implementation costs. This Example demonstrates antenna pattern switching by optical signals, in accordance with some embodiments of the present invention. The architecture in this Example employs high quality ceramic-based driven element and optically switchable reflectors. The latter elements are realized with a set of split ring resonators, loaded with a tandem of varactors and photodiodes. Resonant frequency of each reflector is controlled with an incident light illumination. Fast switching between optically driven reflectors allows achieving scanning between several directions, which cover the entire 2π azimuth section. The optical switching of the present embodiments can be fast and can allow performing high quality scans over the whole three-dimensional space.

### Introduction

Scanning antennas are in use in many modern applications, including radars, wireless communications and many others. The ability to control the radiation pattern with a high accuracy allows establishing an efficient point-to-point communication, where one or more participants can change their locations during the process. One example is a tracking radar, which needs to follow a moving target in both azimuth and elevation. Recently, automotive industry raised a demand in high-resolution short-range radar-based imaging systems, where high-quality fast scanning small aperture antennas are among the most technologically challenging components. The main engineering tradeoff in those components comes from two contradicting requirements, namely high scanning speed and low cost. In general, two main traditional approaches to beam scanning are in use. The first one is based on mechanical motion, where a motor controls the angular position of highly directive antenna aperture. This technique is frequently used in the field of marine radars, where scanning speeds are not the main factor. Another approach to beam steering is based on antenna phased arrays. In this approach, rather expensive phase shifters are used to control each individual element within the array. While this architecture allows achieving fast all-electronic scanning, realization of high quality and directive beams require employing tens or even hundreds of phase-shifting elements. This approach is used, e.g., in airborne applications, where the sped and scan quality requirements predominates over involved costs of realizations.

Recently, several approaches, complementary to traditional phased arrays have been proposed and demonstrated. The ability to tailor and control the laws of refraction using artificially structured media (metamaterials) is useful for beam shaping and control. In particular, judicially designed surfaces (metasurfaces) can provide capabilities to tailor properties of transmitted and reflected waves. In terms of radio physics terminology, metasurfaces can be viewed as a special example of overpopulated phased arrays. However, deeply subwavelength structuring of surface patterns allow treating those structures by means of generalized Snell laws, which is a very convenient semi-analytical design tool. While the majority of recent metasurface studies concentrate on static configurations, dynamic tenability of electromagnetic properties is more advantageous. Several realizations of dynamically reconfigurable metasurfaces and metasurface-based antennas have been recently demonstrated. The majority of the cases is based on controlling individual resonant elements within an array with voltage-controlled varactor diodes. Tunable capacitance allows shifting resonant responses of individual elements, and as the result, either amplitude or phase switchable screens are achieved. While this type of realization does not rely on expensive phase shifters, it still requires using numerous electronic elements, and, even more critically, a branched set of wires to drive them. While in reflect arrays configurations those connecting wires can be hide behind a functional surface, in other realizations they can significantly affect electromagnetic performances. For example, a mesh of thin wires with subwavelength spacings has an electromagnetic predominating (and undesired) electromagnetic response.

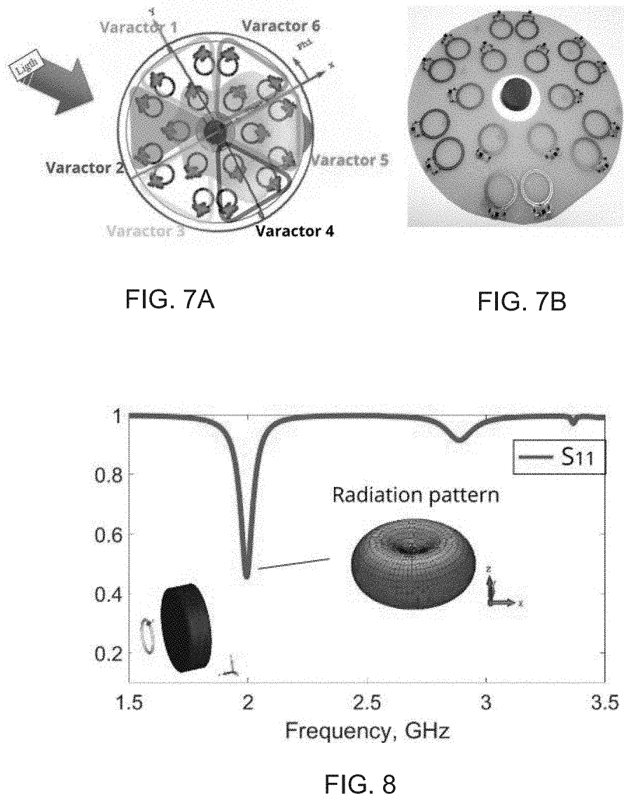

The present embodiments power individual RF elements with light. Light waves do not affect electromagnetic performances and, furthermore, can be delivered via glass optical fibers, which are almost transparent to centimeter and millimeter waves. The concept described in this Example is depicted in FIGS. 7A and 7B. FIG. 7A illustrates the antenna layout. A ceramic-based driven element is surrounded by an array of resonant split ring resonators. Each resonator is loaded with a varactor, powered with a photodiode. Light illumination is applied on a set of three elements, which become resonating with the ceramic disk. An image of the fabricated antenna is shown in FIG. 7B. A metal loop, connected to a standard 50Ω coaxial cable, is placed underneath the ceramic disk. As the result, magnetic dipolar mode is efficiently excited. In order to provide a directivity to this initially isotropic (in plane) patter, an array of split ring resonators (SRR reflectors) is designed around the ceramic disc. SRRs are loaded with the tandem of varactors and photodiodes. The later, once external illumination is applied, powers the variable capacitors. As the result, initially non-resonant reflector can be brought into resonant interaction with the central ceramic element. Dipolar magnetic resonances of the ceramic disc and the SRRs in a certain spatial sections hybridize and directivity pattern is formed. Changing the position of the illuminated sector allows switching directions of the radiated beam.

### Antenna Design

### Driven Element—Ceramic Resonator

In this Example, high quality ceramic elements were used as building blocks in dielectric resonant antennas (DRAs). DRAs offer complimentary solutions to existing printed board-based realizations and can outperform the latter by means of extended bandwidth and reduced internal losses. In This Example, ZrO₂-SnO₂-TiO₂ ceramics are used to ensure impedance-matched excitation of the main driven element.

The standalone cylinder dielectric resonator supports a large number of electromagnetic modes, the frequencies of which depend on the particular geometry and relative permittivity of the material used. The resonator had the following dimensions: diameter D=29.1 mm and height h=9 mm. The dielectric permittivity of the ceramic material was ε=39 and loss tangent tgδ=0.0004 (at 2 GHz, tabulated by the vendor). The frequency of the first magnetic dipolar mode was 2 GHz, which corresponds to the beforehand mentioned nominal.

Dipolar resonance of the cylinder was excited by a wire loop, which was brought to a close proximity. FIG. 8 shows an S-parameter spectrum of cylinder dielectric resonator, excited with a non-resonant conducting loop, according to some embodiments of the present invention. The bottom left inset shows the excitation geometry, and the central inset shows the radiation pattern of the structure, resonating at the first magnetic dipolar mode. Strong near field coupling and the cylindrical symmetry ensures the excitation of the toroidal radiation pattern, corresponding to the magnetic dipolar resonance. S₁₁ parameter of the structure demonstrates a reasonable matching at 2 GHz. The performance can be further improved with an additional optimization of the feeding element.

### Optically Tunable Split Rings Resonators

Varactor diodes are variable capacitance devices, in which nominals can be controlled with an external voltage. Use of SRRs loaded with varactors, is known in the field of metamaterial and metasurfaces architectures. In known realizations, the voltage is supported by a source, connected with conducting wires. In this Example, the required voltage biasing is supplied by photodiodes operating in the photovoltaic mode. As the result, SRR's magnetic resonance can be tuned by changing the intensity of an external light illumination. This architecture is advantageous, since it avoids the use of conducting wires, which significantly affects scattering performances of electromagnetic devices. Furthermore, wires branching and adjutant elements decoupling becomes rather straightforward, significantly simplifying designs and optimizations.

The tunable SRRs of the present embodiments are based on the standard side-coupled geometry, formed by two broken rings. Those are implemented as copper strip lithographically etched on a dielectric substrate (FR4, εᵣ≈4.4). After a set of optimizations, SRRs with the radius of the inner and outer ring of 11 mm and 13 mm respectively were used. The metal strips width was 1 mm, with the gap between the inner and outer rings of 1 mm. The upper split in the outer ring and the symmetric split in the inner ring have the same width of 1 mm.

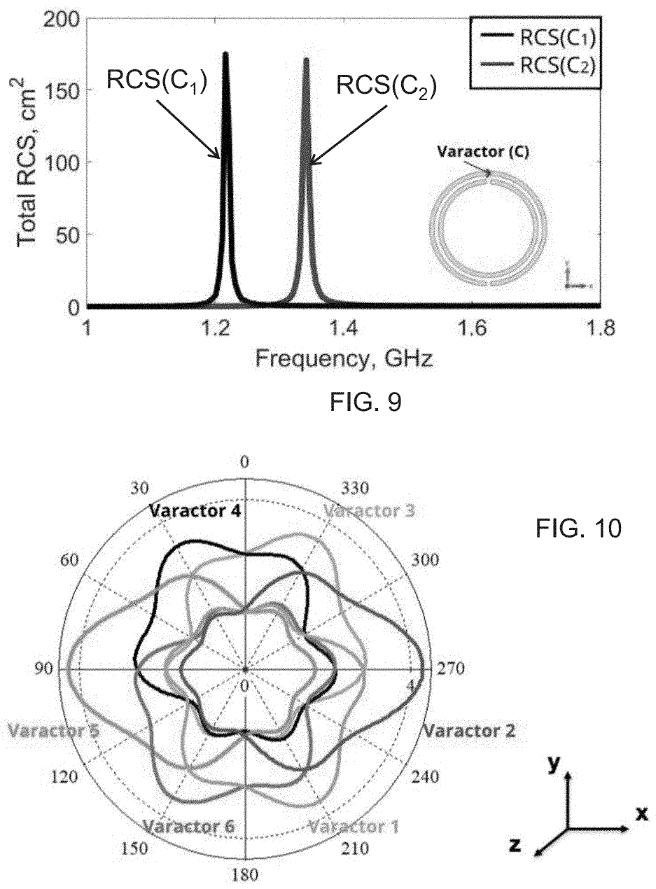

This Example demonstrates a significant spectral shift with experimentally obtainable nominals of the varactor capacitances. FIG. 9 shows the numerically obtained resonance spectra for two nominals. Shift between spectral position of the SRR resonances in light ‘on’ and ‘off’ regimes is around 100 MHz, which corresponds to the change 4 pF of the varactor capacitance. Such a shift on the varactors can be achieved reasonable light intensities, illuminating standard commercial photodiodes, as it will be shown below. The two lines in FIG. 9 correspond to capacitance value of C₁=5 pF and C₂=1 pF. The inset in FIG. 9 illustrates the geometry of side-coupled SRRs.

### Scanning Antenna Design

The scanning antenna architecture is based on the coupling between the beforehand mentioned building blocks. In order to achieve a strong interaction, two resonant structures are bought to a proximity of each other and additional optimization is performed. Intuitively, the antenna operation can be compared with Yagi-Uda design in the following way: central driven element (ceramic disc in the present example) is bounded by reflect array, realized with a set of SRRs. In some embodiments of the present invention the antenna can also include a set of directors, which are not employed in this Example. Unlike a static Yagi-Uda case, the antenna of the present embodiments can optically switch a certain set of reflectors ‘on’ and ‘off’. Reflectors in the ‘off’ state almost do not interact with the driven element and do not affect the radiation pattern.

In the present Example, six groups of three SRRs (one sector), which surround the ceramic disk, are employed. The angle between the sectors is 60 degrees, as shown in FIG. 7B. FIG. 7A illustrates the main switching concept. When a sufficient illumination is applied to a certain sector (shown by a block arrow in FIG. 7A) it becomes resonant with the driven element. As the result, the radiation pattern is directed to the opposite side from the illuminated sector.

The antenna scanning performance is illustrated in FIG. 10, where a set of six directivity patterns are calculated numerically. As shown, that the whole 2π azimuth plane is covered and the moderate antenna directivity (around 4 dBi) is achieved. This value as well as the number of scanning angles can be adjusted and by introducing less or additional reflector elements and/or by combining a set of directors within the design. The light-induced wireless power transfer to individual RF elements, in accordance with some embodiments of the present invention, allows multiplexing reflectors and directors arrays at the same plane without a special effort on decoupling.

### Conclusion

This Example demonstrated an efficient, fast, and low cost antenna scanning based on ceramic-based driven element, surrounded by the array of optically switchable reflectors, realized as split ring resonators, loaded with a tandem of varactors and photodiodes. Resonant frequency of each six-sector reflector was controlled with an incident light. Fast switching between optically driven reflectors allowed achieving scanning between six directions, which cover the entire 2π azimuth section.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

### REFERENCES

[1] Engheta N., Ziolkowski R. W. Metamaterials: Physics and Engineering Explorations//Metamaterials: Physics and Engineering Explorations. 2006.1-414 p.

[2] Capolino F. Applications of metamaterials. 2009.

[3] Smith D. et al. Composite Medium with Simultaneously Negative Permeability and Permittivity//Phys. Rev. Lett. 2000. Vol. 84, No. 18. P. 4184-4187.

[4] Schurig D. et al. Metamaterial electromagnetic cloak at microwave frequencies.//Science. 2006. Vol. 314, No. 5801. P. 977-980.

[5] Simovski C. R. et al. Wire Metamaterials: Physics and Applications//Adv. Mater. 2012. Vol. 24, No. 31. P. 4229-4248.

[6] Fan B. et al. Low-frequency nonlocal and hyperbolic modes in corrugated wire metamaterials//Opt. Express. 2018. Vol. 26, No. 13. P. 17541.

[7] Filonov D. et al. Resonant metasurface with tunable asymmetric reflection//Appl. Phys. Lett. 2018. Vol. 113, No. 9. P. 094103.

[8] Kozlov V. et al. Asymmetric backscattering from the hybrid magneto-electric meta particle//Appl. Phys. Lett. 2016. Vol. 109, No. 20. P. 203503.

[9] T. Kodera, D. L. Sounas, C. Caloz, Appl. Phys. Lett. 2011, 99, 031114.

[10] Yuandan Dong, Itoh T. Metamaterial-Based Antennas//Proc. IEEE. 2012. Vol. 100, No. 7. P. 2271-2285.

[11] Caiazzo M., Maci S., Engheta N. A metamaterial surface for compact cavity resonators//IEEE Antennas Wirel. Propag. Lett. 2004. Vol. 3, No. 1. P. 261-264.

[12] Markovich H. et al. Bifocal Fresnel Lens Based on the Polarization-Sensitive Metasurface//IEEE Trans. Antennas Propag. 2018. Vol. 66, No. 5. P. 2650-2654.

[13] Pendry J. B., Schurig D., Smith D. R. Controlling electromagnetic fields.//Science. 2006. Vol. 312, No. 5781. P. 1780-1782.

[14] Levanon N., Mozeson E. Radar signals. 2004. 411 p.

[15] Zheludev N. I., Plum E. Reconfigurable nanomechanical photonic metamaterials//Nat. Nanotechnol. 2016. Vol. 11, No. 1. P. 16-22.

[16] Bang S. et al. Recent Advances in Tunable and Reconfigurable Metamaterials//Micromachines. 2018. Vol. 9, No. 11. P. 560.

[17] Mohammadi Estakhri N., Al\grave{ù} A. Wave-front Transformation with Gradient Metasurfaces//Phys. Rev. X. 2016. Vol. 6, No. 4. P. 041008.

[18] Sievenpiper D. F. et al. Two-dimensional beam steering using an electrically tunable impedance surface//IEEE Trans. Antennas Propag. 2003. Vol. 51, No. 10. P. 2713-2722.

[19] X. G. Zhang et al., “An optically driven digital metasurface for programming electromagnetic functions,” Nat. Electron., vol. 3, no. 3, pp. 165-171, Mar. 2020.

[20] L. Li and T. J. Cui, “Information metamaterials—from effective media to real-time information processing systems,” Nanophotonics, vol. 8, no. 5, pp. 703-724, March 2019.

[21] M. T. Nouman, H. W. Kim, J. M. Woo, J. H. Hwang, D. Kim, and J. H. Jang, “Terahertz modulator based on metamaterials integrated with metal-semiconductor-metal varactors,” Sci. Rep., vol. 6, no. 1, pp. 1-7, May 2016.

[22]

K. Fan and W. J. Padilla, “Dynamic electromagnetic metamaterials,” in Materials Today, 2015, vol. 18, no. 1, pp. 39-50.

[23] Filonov D. et al. Artificial localized magnon resonances in subwavelength meta-particles//Appl. Phys. Lett. 2018. Vol. 113, No. 12. P. 123505.

[24] Simovski C. R. On electromagnetic characterization and homogenization of nanostructured metamaterials//J. Opt. 2011. Vol. 13, No. 1. P. 013001.

[25] Tsukerman I. Effective parameters of metamaterials: a rigorous homogenization theory via Whitney interpolation//J. Opt. Soc. Am. B. 2011. Vol. 28, No. 3. P. 577.

[26] Silveirinha M. G. Time domain homogenization of metamaterials//Phys. Rev. B. 2011. Vol. 83, No. 16. P. 165104.

[27] Pendry J. B. et al. Extremely Low Frequency Plasmons in Metallic Mesostructures//Phys. Rev. Lett. 1996. Vol. 76, No. 25. P. 4773-4776.

[28] Belov P. A. et al. Strong spatial dispersion in wire media in the very large wavelength limit//Phys. Rev. B. 2003. Vol. 67, No. 11. P. 113103.

[29] Filonov D. S. et al. Controlling electromagnetic scattering with wire metamaterial resonators//J. Opt. Soc. Am. A. 2016. Vol. 33, No. 10. P. 1910.

[30] Nicolson A. M., Ross G. F. Measurement of the Intrinsic Properties of Materials by Time-Domain Techniques//IEEE Trans. Instrum. Meas. 1970. Vol. 19, No. 4. P. 377-382.

[31]

Filonov D. et al. Volumetric 3D-Printed Antennas, Manufactured via Selective Polymer Metallization//Phys. status solidi—Rapid Res. Lett. 2019.

[32] C. A. Balanis, Antenna Theory: Analysis and Design. Wiley-Interscience; 3 edition, 2005.

[33] B. P. Dorta-naranjo, “High range-resolution radar scheme for imaging with tunable distance limits,” Electron. Lett., vol. 40, no. 17, 2004.

[34] R. Komissarov, V. Kozlov, D. Filonov, and P. Ginzburg, “Partially coherent radar unties range resolution from bandwidth limitations,” Nat. Commun., vol. 10, no. 1, p. 1423, December 2019.

[35] C. Holloway, E. F. Kuester, J. Gordon, J. O'Hara, J. Booth, and D. Smith, “An overview of the theory and applications of metasurfaces: The two-dimensional equivalents of metamaterials”, IEEE Trans. Antennas Propag,. vol. 54, pp. 10, 2012.

[36] S. B. Glybovski, S. A. Tretyakov, P. A. Belov, Y. S. Kivshar, and C. R. Simovski, “Metasurfaces: From microwaves to visible”, Phys. Rep., vol. 634, pp. 1, 2016.

[37] C. Pfeiffer and A. Grbic, “Metamaterial Huygen Surfaces\hat{ } Tailoring Wave Fronts with Reflectionless Sheets”, Phys. Rev. Lett., vol. 110, pp. 197401, May 2013.

[38] C. A. Valagiannopoulos, A. Tukiainen, T. Aho, T. Niemi, M. Guina, S. A. Tretyakov, and C. R. Simovski, “Perfect magnetic mirror and simple perfect absorber in the visible spectrum”, Phys. Rev. B, vol. 91, pp. 115305, March 2015.

[39] D. Kajfez and P. Gullion, “Dielectric Resonators”, GA: Noble Publishing Cooperation, pp. 574, 1998.

[40] Polina V. Kapitanova, Alexey P. Slobozhanyuk, Ilya V. Shadrivov, Pavel A. Belov, and Yuri S. Kivshar, “Competing nonlinearities with metamaterials”, Appl. Phys. Lett., vol. 101, pp. 231904, 2012

[41] P. Kapitanova, S. Maslovski, I. Shadrivov, P. Voroshilov, Dmitry S. Filonov, P. Belov and Y. Kivshar “Controlling split-ring resonators with light”, Applied Physics Letters, vol. 99, pp. 251914 (1-3), 2011

What is claimed is:

1. An antenna system, comprising:
an antenna array having a plurality of antenna elements each having a resonator configured for emitting non-optical radiation, and a resonance tuning device for tuning a resonance frequency of said resonator;
an optical array having a plurality of light activated devices respectively aligned with said plurality of antenna elements, and a network of waveguides arranged to guide light to each light activated device, wherein each activated device provides electrical energy to a respective resonance tuning device upon activation by light via a respective waveguide.

2. The system according to claim 1, wherein said arrays are planar.

3. The system according to claim 2, comprising at least two antenna arrays and at least two optical arrays, arranged as a stack such that each optical array is adjacent to an antenna array.

4. The system according to claim 1, comprising an optical controller configured for dynamically controlling coupling of input light into said waveguides so as to dynamically vary a light propagation path along said optical array, hence to control at least one of a shape and a direction of a collective non-optical radiation emitted by said antenna array.

5. The system according to claim 4, wherein said controller is configured to vary said light propagation path according to a fifth-generation communication protocol.

6. The system according to claim 1, wherein at least one of said resonators comprises a split ring resonator.

7. The system according to claim 6, wherein at least one of said resonance tuning device comprises a varactor.

8. The system according to claim 1, wherein at least one of said light activated device comprises a photodiode.

9. The system according to claim 1, wherein said antenna elements and said light activated device are configured to allow each resonance tuning device to reversibly switch a respective resonator between an active and a non-active state for a frequency of said non-optical radiation responsively to said light.

10. The system according to claim 1, wherein said antenna elements and said light activated device are configured to allow each resonance tuning device to shift a resonance frequency of a respective resonator by at least 5%.

11. The system according to claim 1, wherein said non-optical radiation is at a frequency of from about 500 MHz to about 6 GHz.

12. The system according to claim 1, wherein said non-optical radiation is at a frequency of more than 6 GHz.

13. The system according to claim 1, wherein said non-optical radiation is at a frequency of at least 24 GHz.

14. A portable communication device, comprising the system according to claim 1.

15. A base station for distributing communication signals to and from individual portable communication devices, the base station comprising the system according to claim 1.

16. An RFID device, comprising the system according to claim 1.

17. A radar system, comprising the system according to claim 1.

18. An antenna system, comprising:
a plurality of antenna elements arranged on a ceramic element, each antenna element having a resonator and a resonance tuning device for tuning a resonance frequency of said resonator;
a metal loop configured for exciting a magnetic dipolar mode in said ceramic element; and
a plurality of light activated devices arranged such that each light activated device provides electrical energy to a respective resonance tuning device upon activation by light.

19. The system according to claim 18, wherein said ceramic element is shaped as a disc, and said antenna elements are arranged to form circular sectors over said disc.

20. A method of controlling characteristics of an antenna array, the method comprising:
directing light to a plurality of light activated devices to produce electrical signals; and
coupling said electrical signals to an antenna array having a plurality of resonators configured for emitting non-optical radiation, and a plurality of resonance tuning devices that are configured to receive said electrical signals and are arranged to tune resonance frequencies of said resonators, responsively to said electrical signals.
